(19) United States
(12) Patent Application Publication
(10) Pub. No.: US 2011/0137969 A1
(43) Pub. Date: Jun. 9, 2011

(54) APPARATUS AND CIRCUITS FOR SHARED FLOW GRAPH BASED DISCRETE COSINE TRANSFORM

(76) Inventor: MANGESH SADAFALE, Nagpur (IN)

(21) Appl. No.: 12/633,809

(22) Filed: Dec. 9, 2009

(51) Int. Cl. G06F 17/14

(52) U.S. Cl. 708/402

(57) ABSTRACT

An apparatus and circuit for performing a discrete cosine transformation of input signals. A discrete cosine transformation (DCT) apparatus includes a forward adder-tree module, a first set of multiplexers, a shared flow-graph module, an inverse adder-tree module, and a second set of multiplexers coupled in series. In operation, the multiplexers are configured to process input signals via the forward adder-tree module and the shared flow-graph module to perform a forward DCT of the input signals or via the shared flow-graph module and the inverse adder-tree module to perform an inverse discrete cosine transform of the input signals.

### TECHNICAL FIELD

Embodiments of the disclosure generally relates to the field of electronics, and more particularly to discrete cosine transformation (DCT) apparatus and circuits.

### BACKGROUND

Discrete Cosine Transform (DCT) is a technique for representing waveform data as a weighted sum of cosines. DCT is commonly used for data compression of audio or images, as in Joint Photographic Experts Group (JPEG). This usage of DCT results in lossy compression. DCT itself does not lose data; rather, data compression technologies that rely on DCT approximate some of the coefficients of the DCT to reduce the amount of data. DCT is called Forward Discrete Cosine Transform (FDCT) when digital input data in time domain are transformed to digital output data in frequency domain. Conversely, DCT is called Inverse Discrete Cosine Transform (IDCT) when digital input data in frequency domain are transformed to digital output data in time domain. In a variety of applications, FDCT is used in compressing the digital input data, whereas IDCT is used in decompressing the digital input data.

An 8-point (e.g., 8 parallel digital inputs and outputs) FDCT may be represented by the following equation:

$$F ( k ) = \frac{2 c ( k )}{8} {\sum }_{j = 0}^{7} f ( j ) cos [ \frac{( 2 j + 1 ) k * π}{16} ] ,$$

where F(k) represents a digital output data in frequency domain, c(k) represents a constant (e.g., c(k)=1/(2)^{1/2} for k=0 and c(k)=1 for k=1 through 7), f(j) represents digital input data in time domain, and k represents integers ranging between 0 to 7. Further, the below represents a matrix multiplication for the FDCT equation:

$$C ( N ) = cos ( \frac{N \cdot π}{16} ) ,$$

where

$$[ \begin{matrix}F ( 0 ) \\ F ( 1 ) \\ F ( 2 ) \\ F ( 3 ) \\ F ( 4 ) \\ F ( 5 ) \\ F ( 6 ) \\ F ( 7 )\end{matrix} ] = [ \begin{matrix}C ( 4 ) & C ( 4 ) & C ( 4 ) & C ( 4 ) & C ( 4 ) & C ( 4 ) & C ( 4 ) & C ( 4 ) \\ C ( 1 ) & C ( 3 ) & C ( 5 ) & C ( 7 ) & - C ( 7 ) & - C ( 5 ) & - C ( 3 ) & - C ( 1 ) \\ C ( 2 ) & C ( 6 ) & - C ( 6 ) & - C ( 2 ) & - C ( 2 ) & - C ( 6 ) & C ( 6 ) & C ( 2 ) \\ C ( 3 ) & - C ( 7 ) & - C ( 1 ) & - C ( 5 ) & C ( 5 ) & C ( 1 ) & C ( 7 ) & - C ( 3 ) \\ C ( 4 ) & - C ( 4 ) & - C ( 4 ) & C ( 4 ) & C ( 4 ) & - C ( 4 ) & - C ( 4 ) & C ( 4 ) \\ C ( 5 ) & - C ( 1 ) & C ( 7 ) & C ( 3 ) & - C ( 3 ) & - C ( 7 ) & C ( 1 ) & - C ( 5 ) \\ C ( 6 ) & - C ( 2 ) & C ( 2 ) & - C ( 6 ) & - C ( 6 ) & C ( 2 ) & - C ( 2 ) & C ( 6 ) \\ C ( 7 ) & - C ( 5 ) & C ( 3 ) & - C ( 1 ) & C ( 1 ) & - C ( 3 ) & C ( 5 ) & - C ( 7 )\end{matrix} ] * [ \begin{matrix}f ( 0 ) \\ f ( 1 ) \\ f ( 2 ) \\ f ( 3 ) \\ f ( 4 ) \\ f ( 5 ) \\ f ( 6 ) \\ f ( 7 )\end{matrix} ]$$

and the coefficient of the FDCT equation, i.e., ¼, is normalized to 1. FIG. 1 illustrates an 8-point FDCT flow graph 100 according to Chen, Smith, and Fralick's algorithm, where the 8-point FDCT flow graph 100 may be implemented using hardware. In FIG. 1, the 8-point FDCT flow graph 100 includes 26 adders 102-152, which are represented in circles, and 26 multipliers 154-195, which are represented as rectangles. In operation, the 8-point FDCT flow graph 100 generates output signals 198 (e.g., F(0)-F(7)) by processing input signals 196, i.e., f(0)-f(7). For example, F(0) may be obtained using the following equation as illustrated in the highlighted signal paths in FIG. 1: F(0)=C4*((f(0)+f(7))+(f(3)+f(4)))+C4*((f(1)+f(6))+(f(2)+f(5)))=C4*(f(0)+f(1)+f(2)+f(3)+f(4)+f(5)+f(6)+f(7)). Similarly, F(1)-F(7) can be obtained.

An 8-point IDCT may be represented by the following equation:

$$f ( j ) = {\sum }_{k = 0}^{7} c ( k ) F ( k ) cos [ \frac{( 2 j + 1 ) k * π}{16} ] ,$$

where f(j) represents digital output data in time domain, c(k) represents a constant (e.g., c(k)=1/(2)^{1/2} for k=0 and c(k)=1 for k=1 through 7), F(k) represents digital input data in frequency domain, and j represents integers ranging between 0 and 7. Further, the below represents a matrix multiplication for the IDCT equation:

$$C ( N ) = cos ( \frac{N \cdot π}{16} ) .$$

where

$$[ \begin{matrix}f ( 0 ) \\ f ( 1 ) \\ f ( 2 ) \\ f ( 3 ) \\ f ( 4 ) \\ f ( 5 ) \\ f ( 6 ) \\ f ( 7 )\end{matrix} ] = [ \begin{matrix}C ( 4 ) & C ( 1 ) & C ( 2 ) & C ( 3 ) & C ( 4 ) & C ( 5 ) & C ( 6 ) & C ( 7 ) \\ C ( 4 ) & C ( 3 ) & C ( 6 ) & - C ( 7 ) & - C ( 4 ) & - C ( 1 ) & - C ( 2 ) & - C ( 5 ) \\ C ( 4 ) & C ( 5 ) & - C ( 6 ) & - C ( 1 ) & - C ( 4 ) & C ( 7 ) & C ( 2 ) & C ( 3 ) \\ C ( 4 ) & C ( 7 ) & - C ( 2 ) & - C ( 5 ) & C ( 4 ) & C ( 3 ) & - C ( 6 ) & - C ( 1 ) \\ C ( 4 ) & - C ( 7 ) & - C ( 2 ) & C ( 5 ) & C ( 4 ) & - C ( 3 ) & - C ( 6 ) & C ( 1 ) \\ C ( 4 ) & - C ( 5 ) & - C ( 6 ) & C ( 1 ) & - C ( 4 ) & - C ( 7 ) & C ( 2 ) & - C ( 3 ) \\ C ( 4 ) & - C ( 3 ) & C ( 6 ) & C ( 7 ) & - C ( 4 ) & C ( 1 ) & - C ( 2 ) & C ( 5 ) \\ C ( 4 ) & - C ( 1 ) & C ( 2 ) & - C ( 3 ) & C ( 4 ) & - C ( 5 ) & C ( 6 ) & C ( 7 )\end{matrix} ] * [ \begin{matrix}F ( 0 ) \\ F ( 1 ) \\ F ( 2 ) \\ F ( 3 ) \\ F ( 4 ) \\ F ( 5 ) \\ F ( 6 ) \\ F ( 7 )\end{matrix} ]$$

FIG. 2 illustrates an 8-point IDCT flow graph 200 according to Chen, Smith, and Fralick's algorithm, where the 8-point IDCT flow graph 200 may be implemented using hardware. In FIG. 2, the 8-point IDCT flow graph 200 includes 26 adders 202-252 and 26 multipliers 254-295. In operation, the 8-point IDCT flow graph 200 generates output signals 298, i.e., f(0)-f(7), by processing input signals 296, i.e., F(0)-F(7). For example, f(0) may be obtained using the following equation as illustrated in the highlighted signal paths in FIG. 2: f(0)=(C4*F(0)+C4*F(4))+(C2*F(2)+C6*F(6))+(C5*F(5)+C3*F(3))+(C1*F(1)+C7*F(7))=C4*F(0)+C1*F(1)+C2*F(2)+C3*F(3)+C4*F(4)+C5*F(5)+C6*F(6)+C7*F(7). Similarly, f(1)-f(7) can be obtained.

Both the FDCT and IDCT may be employed in parallel in an application, such as a coder-decoder. That is, two separate circuits, such as the ones in FIG. 1 and FIG. 2, may be implemented for the FDCT and IDCT, respectively. As this method employs adders and multiplexers designated for either the FDCT or the IDCT, it may require more space and components to build the circuits.

Alternatively, circuits for both the FDCT and IDCT may be built using a single circuit as illustrated in FIG. 3. FIG. 3 illustrates an 8-point FDCT/IDCT flow graph 300 according to Chen, Smith, and Fralick's algorithm, where the 8-point FDCT/IDCT flow graph 300 may be implemented using hardware. In FIG. 3, the 8-point FDCT/IDCT flow graph 300 includes 36 adders 302-337 and 28 multipliers 350-377, which are represented as rectangles. In operation, the 8-point FDCT/IDCT flow graph 300 generates frequency domain signals 396 based on time domain signals 398 during the FDCT operation, whereas it generates the time domain signals 398 based on the frequency domain signals 396 during the IDCT operation. Although combining the FDCT and IDCT in a single circuit, as shown in FIG. 3, may appear to decrease the number of components in the circuit as well as the size of the circuit, a significant number of multiplexers may need to be added to the circuit in order to process signal flows in two opposite directions with respect to the two types of discrete cosine transforms (DCTs). That is, a multiplexer (e.g., or at least 28 multiplexers in total) may need to be assigned for each adder in the circuit 300 to select or undo the selection of each adder associated with the multiplexer based on the type of DCT. For example, in order to obtain F(0) in the FDCT, among the adders in the signal paths, adders 306, 314, 315, 322, 323, 324, and 325 need to be included, whereas adders 330-337 need to be excluded using respective multiplexers (not shown in FIG. 3). In another example, in order to obtain f(0) in the IDCT, among the adders in the signal paths, adders 312, 313, 314, 317, 321, 322, and 330 need to be included, whereas adders 302-309, and 329 need to be excluded using respective multiplexers (not shown in FIG. 3). Further, one or more logic circuit may need to be implemented to control the multiplexers in the circuit 300 based on the FDCT or IDCT operation. Thus, the additional multiplexers and logic circuit that need to be implemented in the circuit 300 may offset the scaling down effect brought about by implementing both the FDCT/IDCT features to the same circuit.

### SUMMARY

This summary is provided to comply with 37 C.F.R. §1.73, requiring a summary of the invention briefly indicating the nature and substance of the invention. It is submitted with the understanding that it will not be used to interpret or limit the scope or meaning of the claims.

Apparatus and circuits for shared flow graph based discrete cosine transform are disclosed. In one aspect, an apparatus for performing a discrete cosine transformation of input signals includes a forward adder-tree module having a first set of adders and multipliers, where input nodes of the forward adder-tree module are configured to receive input signals. The apparatus also includes a first set of multiplexers with their input nodes connected to output nodes of the forward adder-tree module and configured to receive the input signals. The apparatus further includes a shared flow-graph module having a second set of adders and multipliers, where input nodes of the shared flow-graph module are connected to output nodes of the first set of multiplexers. In addition, the apparatus includes an inverse adder-tree module having a third set of adders and multipliers, where input nodes of the inverse adder-tree module are connected to output nodes of the shared flow-graph module. Moreover, the apparatus includes a second set of multiplexers with their input nodes connected to the output nodes of the shared flow-graph module and to output nodes of the inverse adder-tree module.

In another aspect, a circuit for performing a discrete cosine transformation of input signal includes a forward adder-tree module having twelve adders and six multipliers, where input nodes of the forward adder-tree module are configured to receive eight digital input data in parallel. The circuit also includes a first set of eight multiplexers with their input nodes connected to output nodes of the forward adder-tree module and configured to receive the eight digital input data. The circuit further includes a shared flow-graph module having fourteen adders and twenty multipliers, where input nodes of the shared flow-graph module are connected to output nodes of the first set of eight multiplexers. In addition, the circuit includes an inverse adder-tree module having twelve adders and six multipliers, where input nodes of the inverse adder-tree module are connected to output nodes of the shared flow-graph module. Moreover, the circuit includes a second set of eight multiplexers with their input nodes connected to the output nodes of the shared flow-graph module and to output nodes of the inverse adder-tree module.

Other features of the embodiments will be apparent from the accompanying drawings and from the detailed description that follows.

### BRIEF DESCRIPTION OF THE VIEWS OF DRAWINGS

FIG. 1 illustrates an 8-point FDCT flow graph according to Chen, Smith, and Fralick's algorithm.

FIG. 2 illustrates an 8-point IDCT flow graph according to Chen, Smith, and Fralick's algorithm.

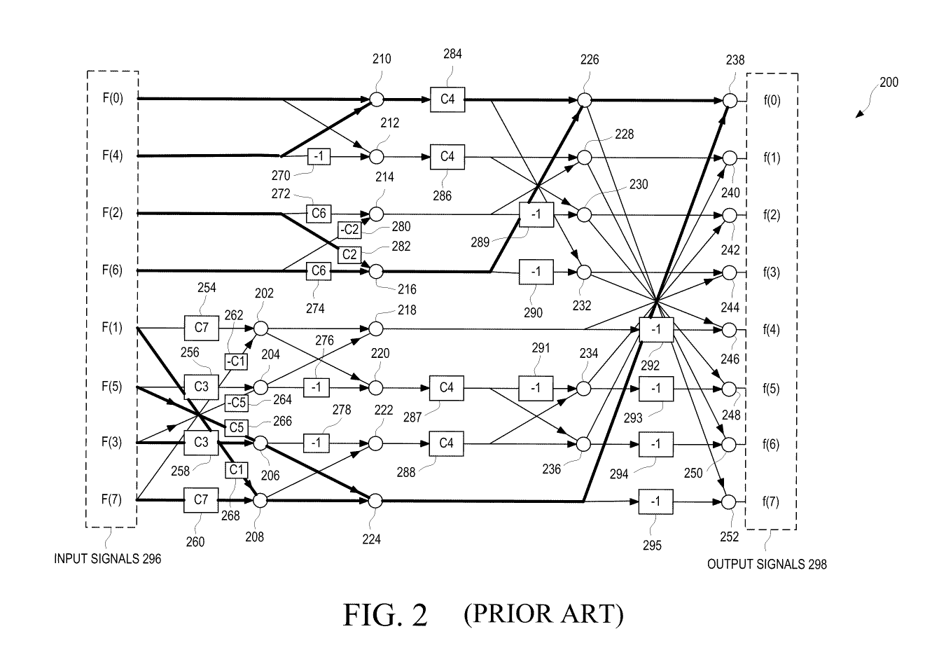

FIG. 3 illustrates an 8-point FDCT/IDCT flow graph according to Chen, Smith, and Fralick's algorithm.

FIG. 4 illustrates a block diagram of an exemplary DCT apparatus, according to one embodiment.

FIG. 5 illustrates an 8-point IDCT flow graph including an exemplary shared flow-graph module and an exemplary inverse adder-tree module, according to one embodiment.

FIG. 6 illustrates a simplified version of the 8-point FDCT flow graph in FIG. 1.

FIG. 7 illustrates an 8-point FDCT flow graph including an exemplary forward adder-tree module and the shared flow-graph module of FIG. 5, according to one embodiment.

FIG. 8 illustrates a schematic diagram of an exemplary DCT circuit, according to one embodiment.

The drawings described herein are for illustration purposes only and are not intended to limit the scope of the present disclosure in any way.

### DETAILED DESCRIPTION

Apparatus and circuits for shared flow graph based discrete cosine transform are disclosed. The following description is merely exemplary in nature and is not intended to limit the present disclosure, applications, or uses. It should be understood that throughout the drawings, corresponding reference numerals indicate like or corresponding parts and features.

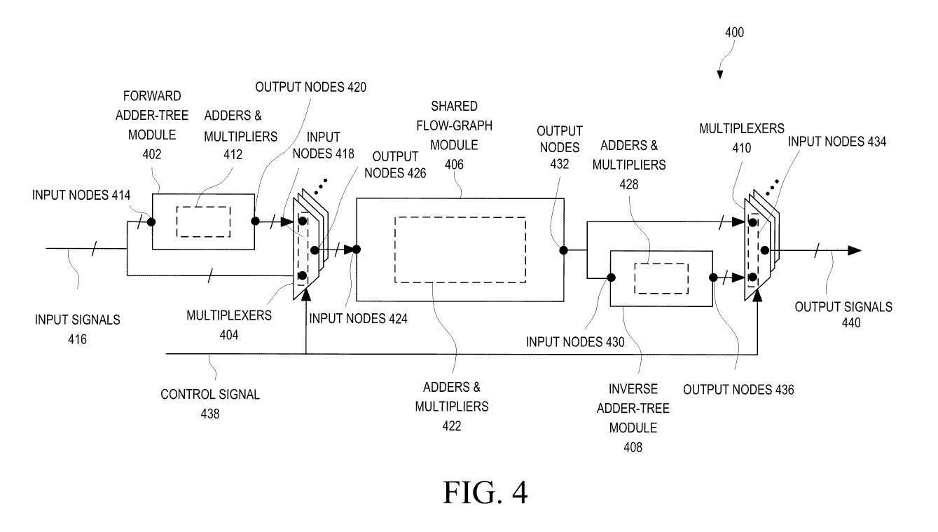

FIG. 4 illustrates a block diagram of an exemplary DCT apparatus 400, according to one embodiment. The DCT apparatus 400 includes a forward adder-tree module 402, multiplexers 404, a shared flow-graph module 406, an inverse adder-tree module 408, and multiplexers 410. The forward adder-tree module 402 includes adders and multipliers 412, and input nodes 414 of the forward adder-tree module 402 are configured to receive input signals 416. The multiplexers 404 have their input nodes 418 connected to output nodes 420 of the forward adder-tree module 402, where the input nodes 418 of the multiplexers 404 are also configured to receive the input signals 416. The shared flow-graph module 406 includes adders and multipliers 422, and input nodes 424 of the shared flow-graph module 406 are connected to output nodes 426 of the first set of multiplexers 404. The inverse adder-tree module 408 includes adders and multipliers 428, and input nodes 430 of the inverse adder-tree module 408 are connected to output nodes 432 of the shared flow-graph module 406. The multiplexers 410 have their input nodes 434 connected to the output nodes 432 of the shared flow-graph module 406 and to output nodes 436 of the inverse adder-tree module 408.

In an example operation, based on a control signal 438 received, the multiplexers 404 and the multiplexers 410 are configured to process the input signals 416 via the forward adder-tree module 402 and the shared flow-graph module 406 to perform a FDCT operation of the input signals 416. That is, the multiplexers 404 are configured to select respective signals from the output nodes 420 of the forward adder-tree module 402, and the multiplexers 410 are configured to select respective signals from the output nodes 432 of the shared flow-graph module 406 during the FDCT operation of the input signals 416. Accordingly, the multiplexers 410, via its output node, generate output signals 440 from the FDCT operation of the input signals 416.

In another example operation, the multiplexers 404 and the multiplexers 410 are configured to process the input signals 416 via the shared flow-graph module 406 and the inverse adder-tree module 408 to perform an IDCT operation of the input signals 416. That is, based on the control signal 438 received, the multiplexers 404 are configured to select the input signals 416, and the multiplexers 410 are configured to select respective signals from the output nodes 436 of the inverse adder-tree module 408 during the IDCT operation of the input signals 416. Accordingly, the multiplexers 410 generate output signals 440 from the IDCT operation of the input signals 416.

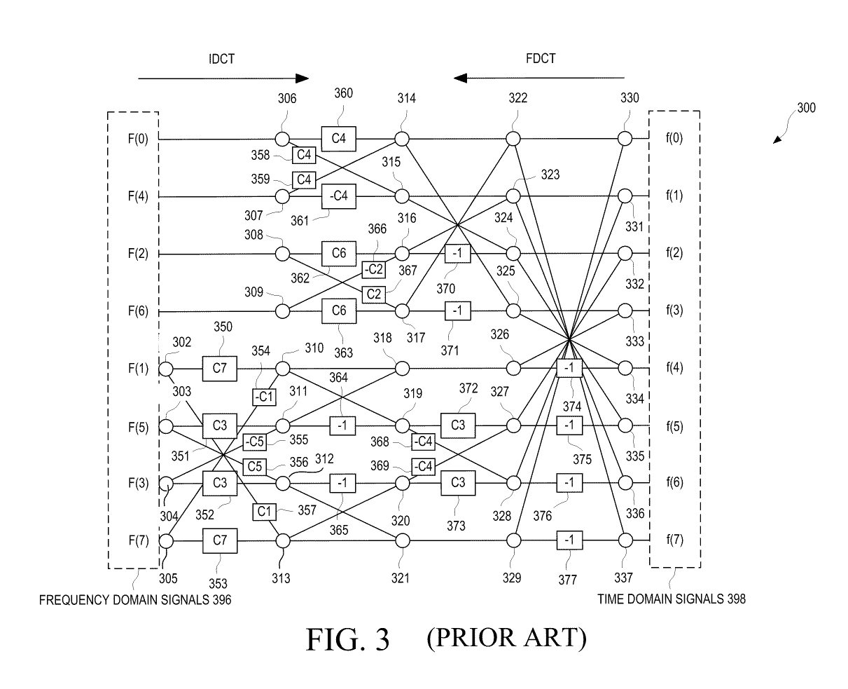

It is appreciated that the shared flow-graph module 406 is used for both the FDCT and IDCT operations, and this may make it possible to build the DCT apparatus 400 using a reduced number of components, such as adders and multipliers. It is further appreciated that the shared flow-graph module 406 of the DCT apparatus 400 processes signals in a single direction for both the FDCT and IDCT operations, whereas conventional DCT apparatus, such as the one shown in FIG. 3, may need additional electronic components, such as multiplexers, to handle signals flowing in opposite directions during the FDCT and IDCT operations.

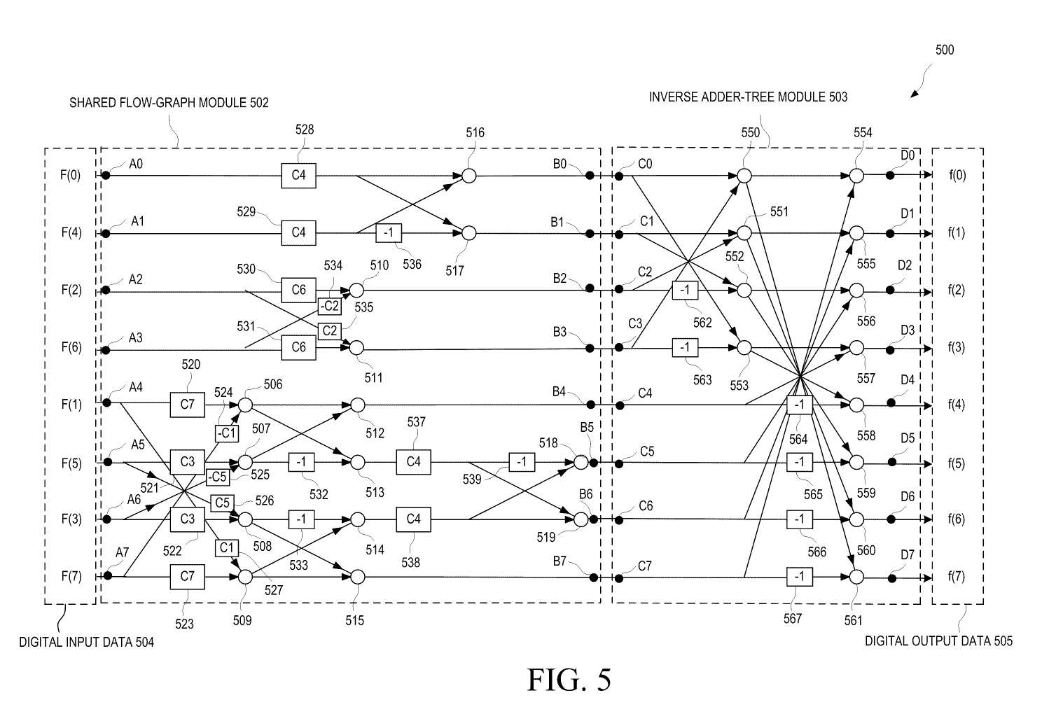

FIG. 5 illustrates an 8-point IDCT flow graph 500 comprising an exemplary shared flow-graph module 502 and an exemplary inverse adder-tree module 503, according to one embodiment. It is appreciated that the shared flow-graph module 502 is an exemplary embodiment of the shared flow-graph module 406 of FIG. 4. It is also appreciated that the inverse adder-tree module 503 is an exemplary embodiment of the inverse adder-tree module 408. The 8-point IDCT flow graph 500, when implemented using components (e.g., adders 506-519 and 550-561 and multipliers 520-539 and 562-567), performs an IDCT operation to digital input data 504 (e.g., eight digital input data in parallel F(0)-F(7)) in frequency domain to generate digital output data 505 (e.g., eight digital output data in parallel f(0)-f(7)) in time domain.

As illustrated in FIG. 5, the shared flow-graph module 502 includes fourteen adders (e.g., the adders 506-519) and twenty multipliers (e.g., the multipliers 520-539). Each adder takes two inputs and generates a single output. Each multiplier is configured to multiply its input value by a fixed coefficient, which includes −C1 or −pi/16, C1 or pi/16, −2 C or −pi/8, 2 C or pi/8, 3 C or 3pi/16, 4 C or pi/4, −5 C or −5pi/16, 5 C or 5pi/16, 6 C or 6pi/16, 7 C or 7pi/16, and −1. The inverse adder-tree module 503 includes twelve adders (e.g., the adders 550-561) and six negative unity multipliers (e.g., the multipliers 562-567). Each adder takes two inputs and generates a single output. Each multiplier is configured to multiply its input value by −1.

Furthermore, from the shared flow-graph module 502, signals at node B0-B7, i.e., S(B0)-S(B7) may be obtained in terms of signals at nodes A0-A7, i.e., S(A0)-S(A7) as stated below:

S(B0)=C4*S(A0)+C4*S(A1);

S(B1)=C4*S(A0)−C4*S(A1);

S(B2)=C6*S(A2)−C2*S(A3);

S(B3)=C2*S(A2)+C6*S(A3);

S(B4)=C7*S(A4)+C3*S(A5)−C5*S(A6)−C1*S(A7);

S(B7)=C1*S(A4)+C5*S(A5)+C3*S(A6)+C7*S(A7);

using cosine and sine property that cos(x+y)=cos x*cos y−sin x*sin y; cos (x−y)=cos x*cos y+sin x*sin y; sin x=cos(pi/2−x); and cos(pi/4)=sin(pi/4),

$$\begin{matrix}S ( B 5 ) = C 4 * [ - C 5 * S ( A 5 ) - C 3 * S ( A 6 ) + C 1 * S ( A 4 ) + C 7 * S ( A 7 ) ] - \\ C 4 * [ C 7 * S ( A 4 ) - C 1 * S ( A 7 ) - C 3 * S ( A 5 ) + C 5 * S ( A 6 ) ] \\ = C 4 * ( C 1 - C 7 ) * S ( A 4 ) - C 4 * ( C 5 - C 3 ) * S ( A 5 ) - \\ C 4 * ( C 3 + C 5 ) * S ( A 6 ) + C 4 * ( C 7 + C 1 ) * S ( A 7 ) \\ = C 5 * S ( A 4 ) + C 7 * S ( A 5 ) - C 1 * S ( A 6 ) + C 3 * S ( A 7 ) ; and \\ S ( B 6 ) = C 4 * [ C 7 * S ( A 4 ) - C 1 * S ( A 7 ) - ( C 3 * S ( A 5 ) - C 5 * S ( A 6 ) ) ] + \\ C 4 * [ - ( C 5 * S ( A 5 ) + C 3 * S ( A 6 ) ) + C 1 * S ( A 4 ) + C 7 * S ( A 7 ) ] \\ = C 4 * ( C 7 + C 1 ) * S ( A 4 ) - C 4 * ( C 3 + C 5 ) * S ( A 5 ) + \\ C 4 * ( C 5 - C 3 ) * S ( A 6 ) + C 4 * ( C 7 - C 1 ) * S ( A 7 ) \\ = C 3 * S ( A 4 ) - C 1 * S ( A 5 ) - C 7 * S ( A 6 ) - C 5 * S ( A 7 ) ,\end{matrix}$$

where C4*(C1−C7)=C4*C1−C4*C7=cos(4pi/16)*cos(pi/16)−cos(4pi/16)*cos(7pi/16)=cos(4pi/16)*cos(pi/16)−sin(4pi/16)*sin(pi/16)=cos(4pi/16+pi/16)=cos(5pi/16)=C5; −C4*(C5−C3)=C4*C3−C4*C5=cos(4pi/16)*cos(3pi/16)−cos(4pi/16)*cos(5pi/16)=cos(4pi/16)*cos(3pi/16)−sin(4pi/16)*sin(3pi/16)=cos(4pi/16+3pi/16)=cos(7pi/16)=C7; C4*(C3+C5)=C4*C3+C4*C5=cos(4pi/16)*cos(3pi/16)+cos(4pi/16)*cos(5pi/16)=cos(4pi/16)*cos(3pi/16)+sin(4pi/16)*sin(3pi/16)=cos(4pi/16-3pi/16)=cos(pi/16)=C1; and C4*(C7+C1)=C4*C7+C4*C1=cos(4pi/16)*cos(7pi/16)+cos(4pi/16)*cos(pi/16)=cos(4pi/16)*cos(pi/16)+sin(4pi/16)*sin(pi/16)=cos(4pi/16−pi/16)=cos(3pi/16)=C3.

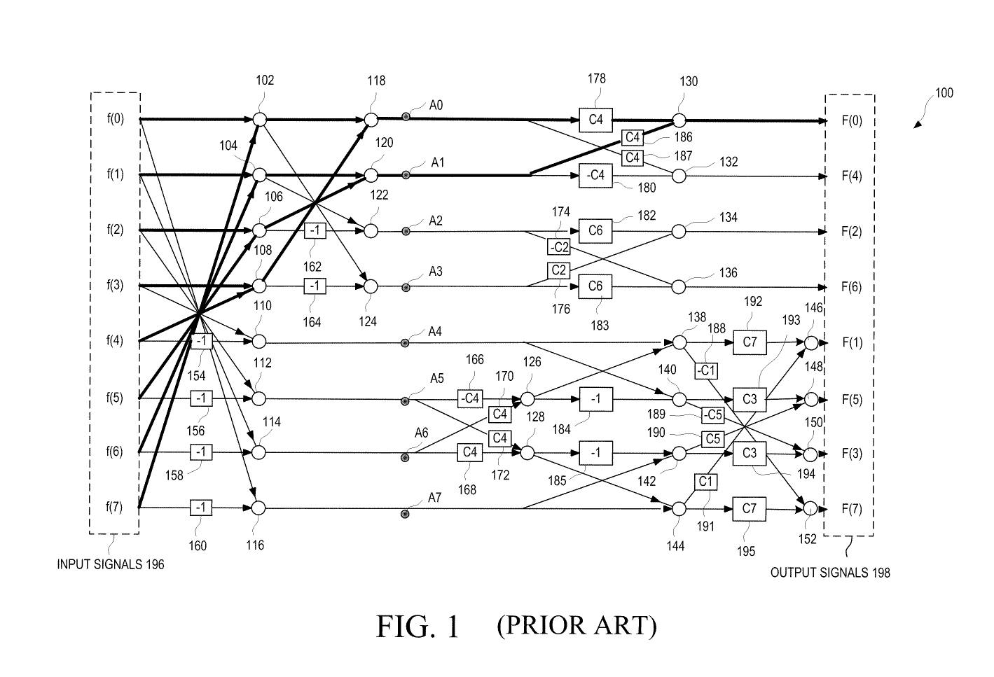

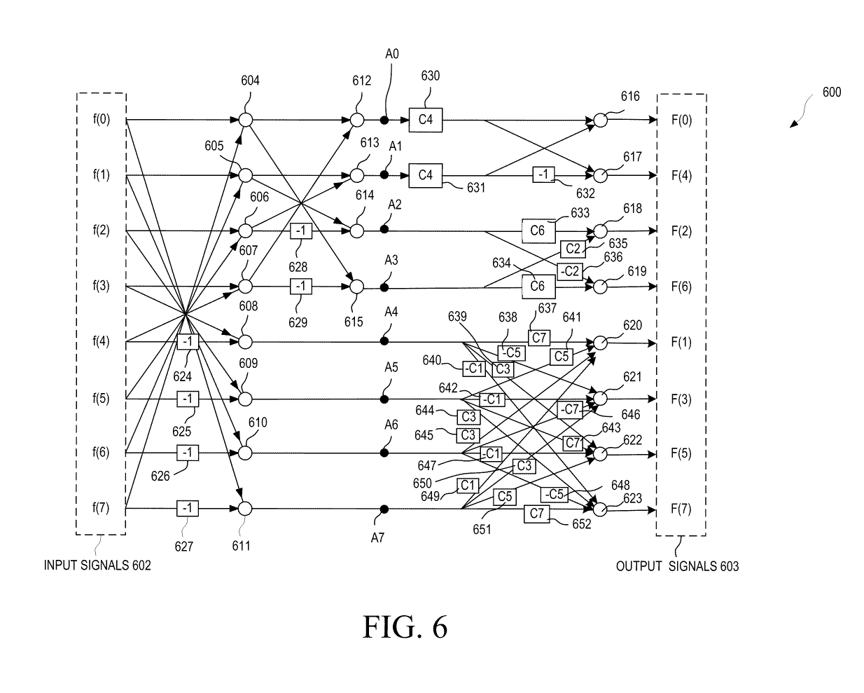

FIG. 6 illustrates a simplified version of the 8-point FDCT flow 100 graph in FIG. 1. In FIG. 1, output signals 198, i.e., F(0)-F(7), may be obtained in terms of signals at nodes A0-A7, i.e., S(A0)-S(A7) as stated in the blow:

F(0)=C4*S(A0)+C4*S(A1);

F(4)=C4*S(A0)−C4*S(A1);

F(2)=C6*S(A2)+C2*S(A3);

F(6)=C6*S(A3)−C2*S(A2);

using cosine and sine property that cos (x+y)=cos x*cos y−sin x*sin y; cos (x−y)=cos x*cos y+sin x*sin y; sin x=cos(pi/2−x); and cos(pi/4)=sin(pi/4),

$$\begin{matrix}F ( 1 ) = C 7 * [ S ( A 4 ) + C 4 * ( S ( A 6 ) - S ( A 5 ) ) ] + \\ C 1 * [ S ( A 7 ) + C 4 * S ( A 5 ) + C 4 * S ( A 6 ) ] \\ = C 7 * S ( A 4 ) + C 4 * ( C 1 - C 7 ) * S ( A 5 ) + \\ C 4 * ( C 1 + C 7 ) * S ( A 6 ) + C 1 * S ( 7 ) \\ = C 7 * S ( A 4 ) + C 5 * S ( A 5 ) + C 3 * S ( A 6 ) + C 1 * S ( A 7 ) ; \\ F ( 3 ) = - C 5 * [ S ( A 4 ) + - ( C 4 * S ( A 6 ) - C 4 * S ( A 5 ) ) ] + \\ C 3 * [ S ( A 7 ) - ( C 4 * S ( A 5 ) + C 4 * S ( A 6 ) ) ] \\ = - C 5 * S ( A 4 ) - C 4 * ( C 3 + C 5 ) * S ( A 5 ) + \\ C 4 * ( C 5 - C 3 ) * S ( A 6 ) + C 3 * S ( A 7 ) \\ = - C 5 * S ( A 4 ) - C 1 * S ( A 5 ) - C 7 * S ( A 6 ) + C 3 * S ( A 7 ) ; \\ F ( 5 ) = C 3 * [ S ( A 4 ) - C 4 * S ( A 6 ) + C 4 * S ( A 5 ) ] + \\ C 5 * [ S ( A 7 ) - C 4 * ( S ( A 5 ) + S ( A 6 ) ) ] \\ = C 3 * S ( A 4 ) + C 4 * ( C 3 - C 5 ) * S ( A 5 ) - \\ C 4 * ( C 3 + C 5 ) * S ( A 6 ) + C 5 * S ( A 7 ) \\ = C 3 * S ( A 4 ) + C 7 * S ( A 5 ) - C 1 * S ( A 6 ) + C 5 * S ( A 7 ) ; and \\ F ( 7 ) = - C 1 * [ S ( A 4 ) + C 4 * ( S ( A 6 ) - S ( A 5 ) ) ] + \\ C 7 * [ C 4 * ( S ( A 5 ) + S ( A 6 ) + S ( A 7 ) ) ] \\ = - C 1 * S ( A 4 ) + C 4 * ( C 7 + C 1 ) * S ( A 5 ) + \\ C 4 * ( C 7 - C 1 ) * S ( A 6 ) + C 7 * S ( A 7 ) \\ = - C 1 * S ( A 4 ) + C 3 * S ( A 5 ) - C 5 * S ( A 6 ) + C 7 * S ( A 7 ) ,\end{matrix}$$

where C4*(C1−C7)=C4*C1−C4*C7=cos(4pi/16)*cos(pi/16)−cos(4pi/16)*cos(7pi/16)=cos(4pi/16)*cos(pi/16)−sin(4pi/16)*sin(pi/16)=cos(4pi/16+pi/16)=cos(5pi/16)=C5; −C4*(C5−C3)=C4*C3−C4*C5=cos(4pi/16)*cos(3pi/16)−cos(4pi/16)*cos(5pi/16)=cos(4pi/16)*cos(3pi/16)−sin(4pi/16)*sin(3pi/16)=cos(4pi/16+3pi/16)=cos(7pi/16)=C7; C4*(C3+C5)=C4*C3+C4*C5=cos(4pi/16)*cos(3pi/16)+cos(4pi/16)*cos(5pi/16)=cos(4pi/16)*cos(3pi/16)+sin(4pi/16)*sin(3pi/16)=cos(4pi/16-3pi/16)=cos(pi/16)=C1; and C4*(C7+C1)=C4*C7+C4*C1=cos(4pi/16)*cos(7pi/16)+cos(4pi/16)*cos(pi/16)=cos(4pi/16)*cos(pi/16)+sin(4pi/16)*sin(pi/16)=cos(4pi/16−pi/16)=cos(3pi/16)=C3.

FIG. 6 represents the simplified version of the FDCT flow graph 100, where output signals 603, i.e., F(0)-F(7), are represented in terms of the signals at nodes A0-A7 based on the coefficients calculated above, such as −C1, C1, −C2, C2, C3, C4, −C5, C5, C6, −C7, C7, and −1. When S(B0)-S(B7) of FIG. 5 and F(0)-F(7) calculated earlier are compared, the followings are observed:

(1) F(0) and S(B0) is equivalent.

(2) F(4) and S(B1) is equivalent.

(3) F(2) becomes equivalent to S(B3) if S(A2) and S(A3) are crossed.

(4) F(6) becomes equivalent to S(B2) if S(A2) and S(A3) are crossed.

(5) F(1) becomes equivalent to S(B7) if S(A4) and S(A7) are crossed.

(6) F(3) becomes equivalent to S(B6) if S(A4) and S(A7) are crossed.

(7) F(5) becomes equivalent to S(B5) if S(A4) and S(A7) are crossed.

(8) F(7) becomes equivalent to S(B4) if S(A4) and S(A7) are crossed.

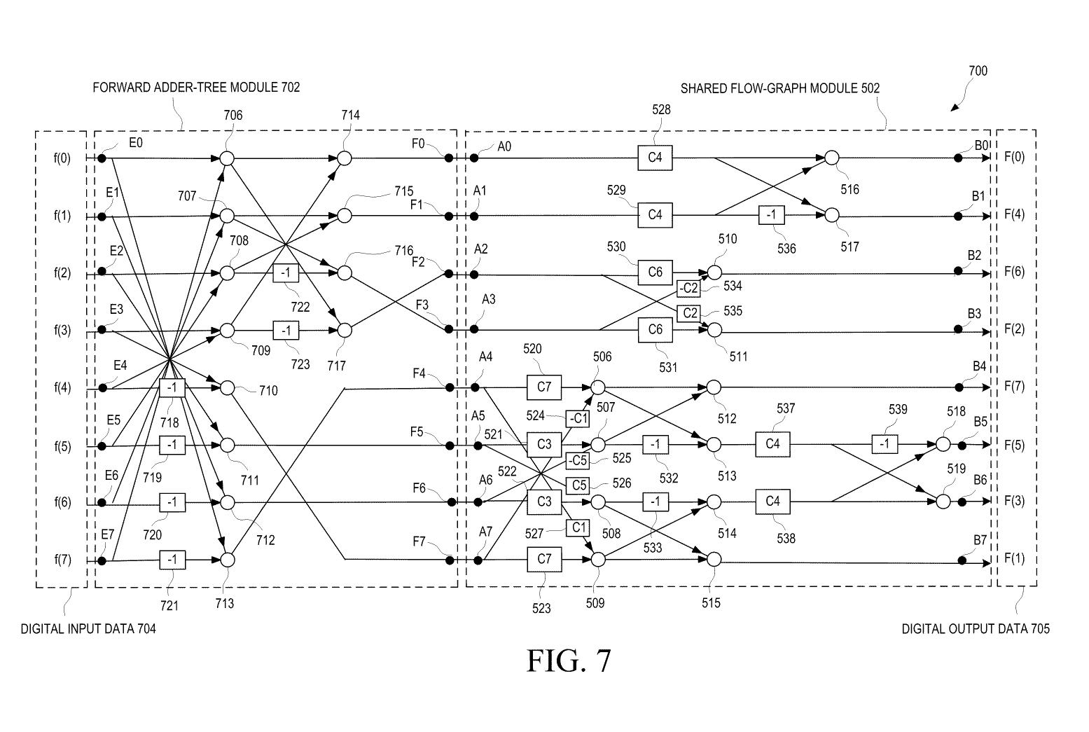

By using the relationships, the shared flow-graph 502 can be formed in the 8-point FDCT flow graph 100, as will be illustrated in FIG. 7. That is, by crisscrossing node A2 and A3 as well as nodes A4 and A7, the shared flow-graph 502 can be formed in the 8-point FDCT flow graph 100.

FIG. 7 illustrates an 8-point FDCT flow graph 700 comprising an exemplary forward adder-tree module 702 and the shared flow-graph module 502 of FIG. 5, according to one embodiment. It is appreciated that the forward adder-tree module 702 is an exemplary embodiment of the forward adder-tree module 402 of FIG. 4. The 8-point FDCT flow graph 700, when implemented using components (e.g., adders 706-717 and 506-519 and multipliers 718-723 and 520-539), performs a FDCT operation to digital input data 704 (e.g., eight digital input data in parallel f(0)-f(7)) in time domain to generate digital output data 705 (e.g., eight digital output data in parallel F(0)-F(7)) in frequency domain.

As illustrated in FIG. 7, the forward adder-tree module 703 includes twelve adders (e.g., the adders 706-717) and six negative unity multipliers (e.g., the multipliers 718-723). Each adder takes two inputs and generates a single output. Each multiplier is configured to multiply its input value by −1. The shared flow-graph module 502 includes fourteen adders (e.g., the adders 506-519) and twenty multipliers (e.g., the multipliers 520-539). Each adder takes two inputs and generates a single output. Each multiplier is configured to multiply its input value by a fixed coefficient, which includes −C1 or −pi/16, C1 or pi/16, −2 C or −pi/8, 2 C or pi/8, 3 C or 3pi/16, 4 C or pi/4, −5 C or −5pi/16, 5 C or 5pi/16, 6 C or 6pi/16, 7 C or 7pi/16, and −1.

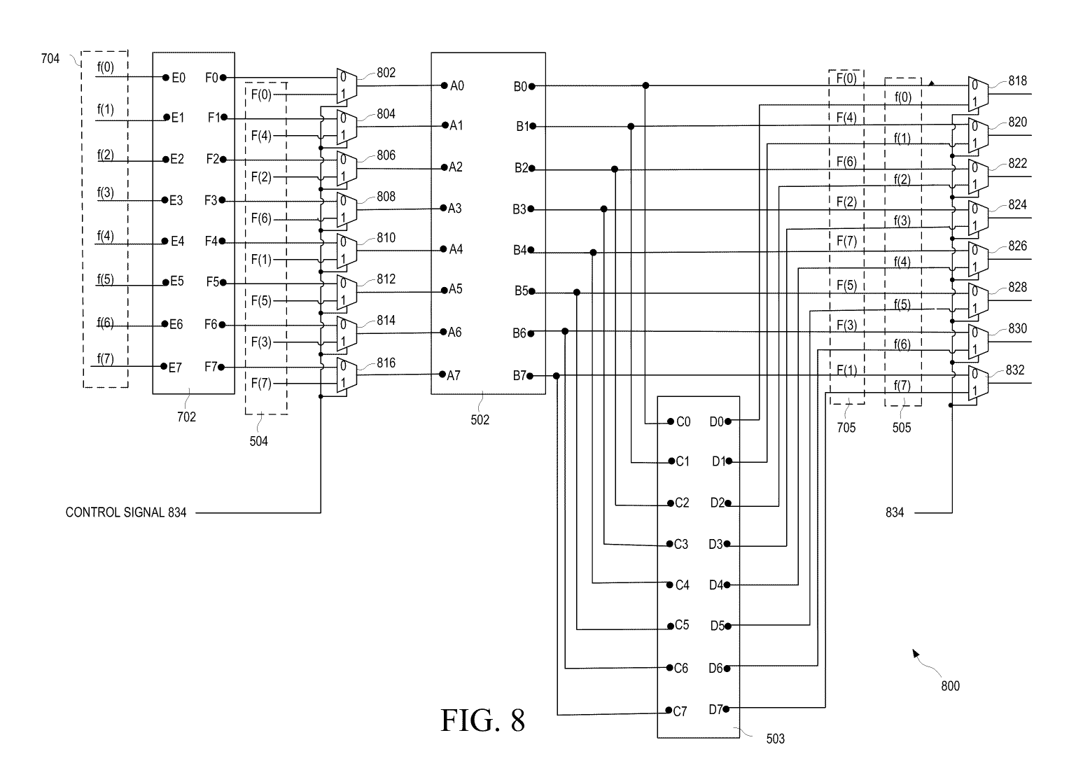

FIG. 8 illustrates a schematic diagram of an exemplary DCT circuit 800, according to one embodiment. The DCT circuit 800 includes the forward adder-tree module 702 of FIG. 7, eight multiplexers 802-816, the shared flow-graph module 502 of FIG. 5, the inverse adder-tree module 503, and eight multiplexers 818-832. Input nodes E0-E7 of the forward adder-tree module 702 are configured to receive the digital input data 704. Input nodes of the eight multiplexers 802-816 are connected to output nodes F0-F7 of the forward adder-tree module 702 and configured to receive the digital input data 704. Input nodes A0-A7 of the shared flow-graph module 502 are connected to output nodes of the eight multiplexers 802-816. Input nodes C0-C7 of the inverse adder-tree module 503 are connected to output nodes B0-B7 of the shared flow-graph module 502. Input nodes of the eight multiplexers 818-832 are connected to the output nodes B0-B7 of the shared flow-graph module 502 and output nodes D0-D7 of the inverse adder-tree module 503.

As illustrated in FIG. 8, each one of the eight multiplexers 802-832 is a two-to-one multiplexer. In one example operation of the DCT circuit 800, the eight multiplexers 802-816 are configured to select respective signals from the output nodes F0-F7 of the forward adder-tree module 702 and the eight multiplexers 818-832 are configured to select respective signals from the output nodes B0-B7 of the shared flow-graph module 502 upon receiving ‘0’ as their control signal 834. Further, the eight multiplexers 818-832 are configured to generate the digital output data 705 in parallel, i.e., F(0)-F(7), which represent a FDCT operation of the digital input data 704.

In another example operation of the DCT circuit 800, the eight multiplexers 802-816 are configured to select the digital input data 704 and the eight multiplexers 818-832 are configured to select respective signals from the output nodes D0-D7 of the inverse adder-tree module 503 upon receiving ‘1’ as their control signal 834. The eight multiplexers 818-832 are configured to generate the digital output data 505 in parallel, i.e., f(0)-f(7), which represent an IDCT operation of the digital input data 504.

The various devices, modules, analyzers, generators, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium). Further, the various electrical structure and methods may be embodied using transistors, logic gates, and/or electrical circuits (e.g., application specific integrated circuit (ASIC)). Although the present embodiments have been described with reference to specific example embodiments, it will be evident that various modifications and changes may be made to these embodiments without departing from the broader spirit and scope of the various embodiments. For example, the present embodiments are discussed in terms of one-dimensional DCT. However, the present embodiments can be applied to multi-dimensional DCT as it is same as multi-pass DCT with transposed output. For instance, two-dimensional DCT, which is the basis of JPEG and video coder/decoder technologies, is simply the one-dimensional DCT performed along the rows and then along the columns, or vice versa, of an image or matrix.

What is claimed is:

1. An apparatus for performing a discrete cosine transformation of input signals, comprising:
a forward adder-tree module comprising a first set of adders and multipliers, wherein input nodes of the forward adder-tree module are configured to receive input signals;
a first set of multiplexers, wherein input nodes of the first set of multiplexers are connected to output nodes of the forward adder-tree module and configured to receive the input signals;
a shared flow-graph module comprising a second set of adders and multipliers, wherein input nodes of the shared flow-graph module are connected to output nodes of the first set of multiplexers;
an inverse adder-tree module comprising a third set of adders and multipliers, wherein input nodes of the inverse adder-tree module are connected to output nodes of the shared flow-graph module; and
a second set of multiplexers, wherein input nodes of the second set of multiplexers are connected to the output nodes of the shared flow-graph module and output nodes of the inverse adder-tree module.

2. The apparatus of claim 1, wherein the first set of multiplexers and the second set of multiplexers are configured to process the input signals via the forward adder-tree module and the shared flow-graph module to perform a forward discrete cosine transform of the input signals.

3. The apparatus of claim 2, wherein the first set of multiplexers are configured to select respective signals from the output nodes of the forward adder-tree module and the second set of multiplexers are configured to select respective signals from the output nodes of the shared flow-graph module during the forward discrete cosine transform of the input signals.

4. The apparatus of claim 1, wherein the first set of multiplexers and the second set of multiplexers are configured to process the input signals via the shared flow-graph module and the inverse adder-tree module to perform an inverse discrete cosine transform of the input signals.

5. The apparatus of claim 4, wherein the first set of multiplexers are configured to select the input signals and the second set of multiplexers are configured to select respective signals from the output nodes of the inverse adder-module during the inverse discrete cosine transform of the input signals.

6. The apparatus of claim 1, wherein the input signals comprise eight digital input data in parallel.

7. The apparatus of claim 6, wherein the first set of adders and multipliers comprise twelve adders and six negative unity multipliers.

8. The apparatus of claim 6, wherein the third set of adders and multipliers comprise twelve adders and six negative unity multipliers.

9. The apparatus of claim 6, wherein the second set of adders and multipliers comprise fourteen adders and twenty multipliers.

10. The apparatus of claim 9, wherein the twenty multipliers are configured to multiply their input values by fixed coefficients, the fixed coefficient comprising −pi/16, pi/16, −pi/8, pi/8, 3pi/16, pi/4, −5pi/16, 5pi/16, 6pi/16, 7pi/16, and −1.

11. The apparatus of claim 6, wherein the first set of multiplexers comprises eight two-to-one multiplexers.

12. The apparatus of claim 6, wherein the second set of multiplexers comprises eight two-to-one multiplexers.

13. A circuit for performing a discrete cosine transformation of input signals, comprising:
a forward adder-tree module comprising twelve adders and six multipliers, wherein input nodes of the forward adder-tree module are configured to receive eight digital input data in parallel;
a first set of eight multiplexers, wherein input nodes of the first set of eight multiplexers are connected to output nodes of the forward adder-tree module and configured to receive the eight digital input data;
a shared flow-graph module comprising fourteen adders and twenty multipliers, wherein input nodes of the shared flow-graph module are connected to output nodes of the first set of eight multiplexers;
an inverse adder-tree module comprising twelve adders and six multipliers, wherein input nodes of the inverse adder-tree module are connected to output nodes of the shared flow-graph module; and
a second set of eight multiplexers, wherein input nodes of the second set of eight multiplexers are connected to the output nodes of the shared flow-graph module and output nodes of the inverse adder-tree module.

14. The circuit of claim 13, wherein each one of the first set of eight multiplexers and the second set of eight multiplexers comprises a two-to-one multiplexer.

15. The circuit of claim 14, wherein the first set of eight multiplexers and the second set of eight multiplexers are configured to select respective signals from the output nodes of the forward adder-tree module and respective signals from the output nodes of the shared flow-graph module, respectively, upon receiving ‘0’ as their control signal.

16. The circuit of claim 15, wherein the second set of eight multiplexers is configured to generate eight digital output data in parallel which represent a forward discrete cosine transform of the eight digital input data.

17. The circuit of claim 14, wherein the first set of eight multiplexers and the second set of eight multiplexers are configured to select the eight digital input data and respective signals from the output nodes of the inverse adder-module, respectively, upon receiving ‘1’ as their control signal.

18. The circuit of claim 17, wherein the second set of eight multiplexers is configured to generate eight digital output data in parallel which represent an inverse discrete cosine transform of the eight digital input data.

19. A circuit for performing a discrete cosine transformation of input signals, comprising:
a forward adder-tree module comprising twelve adders and six negative unity multipliers, wherein input nodes of the forward adder-tree module are configured to receive eight digital input data in parallel;
a first set of eight multiplexers, wherein input nodes of the first set of eight multiplexers are connected to output nodes of the forward adder-tree module and configured to receive the eight digital input data;
a shared flow-graph module comprising fourteen adders and twenty multipliers, wherein input nodes of the shared flow-graph module are connected to output nodes of the first set of eight multiplexers, and wherein the twenty multipliers are configured to multiply their input values by fixed coefficients, the fixed coefficient comprising −pi/16, pi/16, −pi/8, pi/8, 3pi/16, pi/4, −5pi/16, 5pi/16, 6pi/16, 7pi/16, and −1;
an inverse adder-tree module comprising twelve adders and six negative unity multipliers, wherein input nodes of the inverse adder-tree module are connected to output nodes of the shared flow-graph module; and
a second set of eight multiplexers, wherein input nodes of the second set of eight multiplexers are connected to the output nodes of the shared flow-graph module and output nodes of the inverse adder-tree module.

20. The circuit of claim 19, wherein each one of the first set of eight multiplexers and the second set of eight multiplexers comprises a two-to-one multiplexer.
